(19) United States
(12) Patent Application Publication
(10) Pub. No.: US 2024/0314130 A1
(43) Pub. Date: Sep. 19, 2024

(54) DEVICE AND METHOD FOR THE SECURE PROCESSING OF DATA

(71) Applicant: REAL-CIS GMBH, Langen (DE)

(72) Inventors: Hubert JÄGER, Pullach (DE); Edmund ERNST, München (DE); Karl-Heinz SCHAINK, Oberhaching (DE)

(73) Assignee: REAL-CIS GMBH, Langen (DE)

(21) Appl. No.: 18/272,449

(22) PCT Filed: Jan. 10, 2022
(86) PCT No.: PCT/EP2022/050328

§ 371 Date: Jul. 14, 2023

(30) Foreign Application Priority Data
Jan. 26, 2021 (EP) 21153593.5

(51) Int. Cl. H04L 9/40

(52) U.S. Cl. CPC H04L 63/10

(57) ABSTRACT

The invention relates to a device and a method for distributing data processing tasks to the nodes of a network implementing a data processing system and to a device and a method for sealing nodes of a network implementing a data processing system for the efficient provision of a secure data processing system.

The invention relates to a device and a method for distributing data processing tasks to the nodes of a network implementing a data processing system, and to a device and a method for sealing nodes of a network implementing a data processing system for the efficient provision of a secure data processing system.

The welfare of society as a whole depends to a large extent on the functionality of “critical infrastructures” or “system-relevant devices”. Not only communication and information technology systems and the media, which were digitized first, but also intrinsically non-digital systems are increasingly being “digitized”, that is to say they are provided with sensors the measurement signals of which are converted into digital signals, enhanced with actuators that are controlled with digital signals, and equipped with input and output interfaces for human-machine interaction. Digital technology is thus penetrating more and more areas of life, and the resulting advantages have become indispensable. The advantages of digitization are based to a large extent on the networking of digitized apparatuses and devices. These interact directly with one another only in rare cases. Central servers generally coordinate the flow of data. However, this means that society's dependency on the reliable and trustworthy provision and maintenance of central data processing systems is growing constantly and at breakneck speed.

Due to the high dynamics of economic and technical development and the different constraints in different parts of the world, there are considerable power imbalances in the supply chains for digital systems. For example, the chips for the processors as used in servers of the data processing systems in data centers come from only two or three manufacturers who are at present all headquartered in the United States of America. The race to catch up in order to be able to provide this technology as well is costly and is currently only being undertaken in planned economy environments such as China, for instance. Another example is high-performance routers and switches for central computing infrastructures, which are at present likewise only supplied, in the desired number and range of the interfaces, by manufacturers from the USA and China.

Even more so than in the case of hardware components, there is a concentration of power among the providers of computing platforms (Platform as a Service, PaaS). The functions provided by such platforms make software development and the provision of Software as a Service (SaaS) relatively simple and fast. In particular, the proprietary data and infrastructure services provided by large platform providers that go beyond mere hosting, for instance database services or redundancy structures, make the work of software engineers easier and significantly shorten the product development cycles for SaaS offerings. However, this is how platform providers lure their customers, the SaaS providers, into a trap. As soon as the software of the SaaS providers is established based inter alia on the proprietary data and infrastructure services, the SaaS providers are not able to switch to another platform provider without major migration costs. They get caught in what is known as vendor lock-in. A global oligopoly of major platform providers is thus currently being consolidated.

This concentration of large parts of society's digital infrastructure on such oligopoly platforms entails risks for the reliability and sovereignty of data processing in three respects:
If the oligopolists were to interrupt or discontinue the maintenance or provision of the systems or subsystems for some of the users, this would result in a significant supply gap.
Since the number of very large data centers of all oligopolists taken together is manageably small, they also represent as a whole a relatively sensitive target for sabotaging terrorists or hostile states.
The regulatory framework that applies to the oligopolists may remain incompatible with the legal norms for IT security and data protection in Europe in the long term.

In order to counter this formation of an oligopoly in the field of PaaS providers, European governments are promoting projects to disassemble bundled offerings (for example in the context of the GAIA-X initiative) by promoting the definition of open interfaces, non-discriminatory identity management and the development of alternative, open-source software for data and infrastructure services that make the PaaS offerings so attractive.

With an open design of the data and infrastructure functions, the software implementing them may be operated on different data processing systems and the data and infrastructure services may accordingly also be offered to software developers and SaaS operators for different data processing systems, including for data processing systems that meet the requirements in terms of sovereignty, availability of the system and the data as well as a high level of protection of confidentiality and integrity.

Such data processing systems and methods (referred to in practice as cloud data centers or cloud infrastructure) have the property, provided they are implemented carefully, that multiple nodes of a network of servers are prepared for the data processing task using appropriate middleware or cloud operating systems, as currently implemented in open-source mode by [Kubernetes] or [OpenStack] for instance, and are able to take over the data processing task in the event of failure of a server or of the subsystems required for the operation thereof. To this end, access to the (persistent) data associated with the data processing task and also stored permanently and redundantly in multiple nodes of the data processing system must also be possible from the prepared servers. This function is provided by automatically replicating storage systems, such as those currently implemented in open-source mode, for instance by [Ceph] or [OpenIO]. Such a system design results in minimum robustness of the data processing system against sabotage and the failure of individual components and thus minimum protection against loss of availability of the system and the data processed thereby. However, the nodes in which the data processing task is performed are known to the operators and could, if this information is captured, also become known indirectly to potential attackers. If these attackers know the specific locations of the data processing, then the availability of the data processing system and the data processed thereby may be sabotaged relatively easily by concerted attacks, possibly attacks characterized by physical destruction, on the specific majority of the nodes of the network that implement the system.

Provided that they are implemented carefully, such data processing systems and methods also have the property that access for both third parties and the staff operating the data processing system to the data processed by the system is restricted and controlled by technical and organizational measures, as specified for instance in the catalog of requirements of the ISO/IEC Standards in the 27k series or the Bundesamt für Sicherheit in der Informationstechnik (German Federal Office for Information Security) (BSI C5), meaning that a minimum level of protection against unauthorized data access or manipulation of the data processed by the system may thereby be achieved.

However, as long as the design of the data processing system does not comply with the principles of protection against manipulation, that is to say the requirement that changes to the system may only be possible through the cooperation of employees from several different organizations involved in the construction and operation of the data processing system, in the case of data processing systems and methods for protecting confidentiality and integrity, individual employees from the organizations involved in constructing and operating the data processing system may still contravene rules for protecting confidentiality and integrity and, as a result, breach the confidentiality and/or the integrity of the data processed in the data processing system.

The probability of such a breach of confidentiality and/or integrity of the data processed in the data processing system decreases by several (decimal) orders of magnitude if the design principles of the data processing system are complied with in accordance with security against manipulation, as described for instance in [H. A. Jäger et al. (2020). Manipulationssichere Cloud-Infrastrukturen [Tamper-proof cloud infrastructures]. ISBN 978-3-658-31848-2. pages 33-79. Springer Nature.]. Provided that the employees from several different organizations involved in constructing and operating the data processing system are independent, the likelihood of the properties of a tamperproof data processing system being changed and this change being used to breach the confidentiality and/or integrity of the data processed in the data processing system can be estimated as the probability, raised to the power of the number of different independent organizations required for a change, of infidelity of an individual employee from these organizations.

Such tamper-proof data processing systems and the methods that implement them provide a high level of security against breaches of confidentiality and/or integrity of the data processed thereby, in that no data are present in unencrypted form outside of the execution environments provided for the data processing (Trusted Execution Environments, TEE). One example of such chip-level TEEs is implemented by the “Software Guard Extensions” (SGX) from Intel Corporation, described in [I. Anati et al. (2013). Innovative Technology for CPU Based Attestation and Scaling. In Workshop on Hardware and Architectural Support for Security and Privacy HASP'13.]. Another example of implementing such server-level and multi-server-level TEEs is the precautionary deletion of data within a module as soon as an attempted attack is detected, as described for instance in [FIPS PUB 140-2: Security Requirements for Cryptographic Modules. NIST. Jul. 26, 2007. “Security Level 4 provides the highest level of security. At this security level, the physical security mechanisms provide a complete envelope of protection around the cryptographic module with the intent of detecting and responding to all unauthorized attempts at physical access. Penetration of the cryptographic module enclosure from any direction has a very high probability of being detected, resulting in the immediate deletion of all plaintext critical security parameters.”].

Such tamper-proof data processing systems and the methods that implement them also provide a high level of security against breaches of confidentiality and/or integrity if the keys used to encrypt the results and intermediate results of the data processing tasks, as soon as they leave the TEEs, are generated exclusively in the group of nodes of the data processing system and do not leave this group. In order to be able to restart the system even in the event of a simultaneous failure of all nodes of the data processing system, in such tamper-proof data processing systems, a sufficiently large group of mutually independent auditors of the system share an initially automatically generated secret, preferably using the “Shamir Secret Sharing” method [A. Shamir (1979). How to Share a Secret. Programming Techniques. Editor R. Rivest. Communications of the ACM. Vol. 22 No. 11.], which, after successfully completing the audit of a node of the data processing system, they jointly regenerate in the node by entering a sufficient subset of partial secrets (Shamir parts) on a human-machine interface. This secret, which is thereby available to the data processing system, also serves as a trust anchor for the purpose of certifying signed software that is intended to operate the data processing system, as well as signed “userland” software that is executed by the users of the data processing system by said data processing system.

In the data processing systems that correspond to the prior art and the methods that implement them, the maintenance, but at least the testing of the implementation, generally has to be carried out individually by independent on-site auditors, that is to say in the data center in each case individually for each node of the data processing system. In addition to the maintenance and testing of the implementation by independent auditors, the data processing systems that are additionally designed to be tamper-proof and the methods that implement them also include what is known as the “scaling” process of entering the partial secrets in accordance with the Shamir sharing-based method in order to generate a secret common to all nodes of the data processing system on site in the data center.

This results in the disadvantages that the sealing and maintenance always have to be carried out on site, that is to say in the immediate physical vicinity of the individual nodes or in the data centers and, due to the constraints changing from node to node or data center to data center, the sealing and maintenance processes are error-prone and thus the security that is gained is reduced again by new risks, and furthermore, since the majority of independent auditors for the testing and sealing processes each have to appear on site at the same time in coordination with the operator of the data processing system, it is also time-consuming and cost-intensive.

In addition, in such data processing systems, in order to ensure the availability of the system and the data in the event of the failure of individual components, there is a need to provide almost all components twice or even multiple times redundantly at each node of the network. This is not only cost-intensive due to the higher use of resources, but also increases the system complexity, which often runs counter to the aim of protecting system and data availability.

The object of the invention is therefore to provide a system and a method for the secure processing of data, which system and method in particular efficiently prevent sabotage of the data processing system, non-availability of the system or the data due to failure of individual components, unauthorized data access or manipulation of the data, without exhibiting the disadvantages of the systems and methods known from the prior art.

According to the invention, this object is achieved by the methods and devices as claimed in the independent claims. Advantageous developments are specified in the respective dependent claims.

The invention relates to a device and a method in which the robustness against sabotage and failure of individual components is able to be achieved by distributing the data processing task to a plurality of nodes from a network that consists of a multiplicity of nodes, and furthermore, a particularly high level of security against breaches of confidentiality and/or integrity of the data is able to be achieved by encrypting the data during transmission and storage outside the nodes with keys that are available only to the system itself within the network nodes of the system, and furthermore, the nodes may be designed such that they are damaged in the event of attempted attacks in such a way that the data in the affected nodes are destroyed in the process before unauthorized access is successful, or this destruction of the data in the affected nodes takes place as a precautionary measure upon detection of a corresponding attempted attack using systemic mechanisms.

The invention in particular has the following advantages:
1. Since the methods and devices according to the invention are suitable for distributing data processing tasks to the nodes of a network implementing a data processing system, wherein
   (a) a secure environment of the nodes largely prevents unauthorized access by third parties or the staff of the operator of the data processing system,
   (b) the secure environment of a first node initializes the primary instance of a data processing task,
   (c) the one or more secure environments of at least one second node or further nodes initializes the secondary instance or further instances of a data processing task, and
   (d) in the secure environments of the nodes, software-controlled preparation of a plurality of nodes as further instances for the alternative execution of the data processing task takes place by means of pure peer-to-peer management that operates in a manner concealed from the users of the data processing system and the staff of the operator of the data processing system,
   it is almost impossible for potential attackers to sabotage the data processing system, since they cannot practically destroy all nodes and/or their connection to the data transmission and power supply networks at the same time, but also do not know which specific subset of nodes has to be sabotaged in order to interrupt or stop specific data processing tasks for a sensitive duration.
2. Since the methods and devices according to the invention are also suitable for distributing data processing tasks to the nodes of a network implementing a data processing system, the expected values for the data transmission capacities and signal propagation times between the nodes are taken into consideration as criteria of the selection process for the nodes implemented by the pure peer-to-peer management for the preparation of further instances, the delays in data processing that may be insufficient for the various applications are largely avoided, provided that there is a sufficiently dense set-up of sufficiently powerful network nodes.
3. Since the methods and devices according to the invention are also suitable for distributing data processing tasks to the nodes of a network implementing a data processing system, the expected values for the data transmission capacities and/or the signal propagation times for at least one further node and the first node are not deterministic, but rather randomly or quasi-randomly changed expected values are taken into consideration as criteria of the selection method for the nodes implemented by the pure peer-to-peer management for the preparation of a secondary instance, robustness against sabotage is further improved in that the potential attacker cannot know the random or quasi-random distribution of the data processing tasks and the synchronous and asynchronous replications of the data to be processed on the various nodes of the network implementing the data processing system.
4. Since the methods and devices according to the invention are also suitable for distributing data processing tasks to the nodes of a network implementing a data processing system, the expected values for the data transmission capacities and/or the signal propagation times between the first node and further ones are taken into consideration in a manner differentiated by purpose for the synchronous and asynchronous replication of the data as criteria of the selection method for the nodes implemented by the pure peer-to-peer management for the preparation of a secondary instance, the delays in data processing that may be insufficient for the various applications are again largely avoided, provided that there is a sufficiently dense set-up of sufficiently powerful network nodes.
5. Since the methods and devices according to the invention for distributing data processing tasks to the nodes of a network implementing a data processing system are also suitable for designing the nodes of the network implementing the data processing system without local redundancies, that is to say without doubling or higher redundancy in the same node, the usual but costly separate 2-fold or 3-fold component redundancies at each node are obsolete. The simplified node of the network implementing the data processing system, which may also be implemented by distributing the data processing tasks to a large number of nodes, and accordingly with lower bandwidths and capacities, results in a reduction in dependence on oligopolistic supplier structures, since the variety of providers increases as the requirements in terms of bandwidth and capacity decrease.
6. Since the methods and devices according to the invention are suitable for sealing nodes of a network implementing a data processing system for efficiently providing a secure data processing system, wherein
   (a) a secure environment of a first node randomly or quasi-randomly generates an original secret,
   (b) the secure environment of the first node breaks down the original secret into a plurality of partial secrets,
   (c) the secure environment of the first node issues the partial secrets to predetermined auditors,
   (d) a secure environment of a further node receives the partial secrets (after the node has been successfully checked by the auditors) at an interface able to be securely assigned to the node,
   (e) the secure environment of the further node generates the original secret from a sufficient subset of the partial secrets,
   (f) the secure environment of the further node stores the original secret in a volatile data memory provided for this purpose,
   (g) the secure environment of the further node uses the original secret as a cryptographic trust anchor for the start of all further functions of the node signed by the auditors, in particular for the “boot” of the entire “software stack” as well as for the derivation of the keys for the secure persistence of the intermediate results of the data processing tasks and for secure communication between the nodes,
   (h) an energy store supports both a penetration sensor system and the volatile data memory of the secure environment of the further node for a time determined by the capacity of the energy store, even if the node is disconnected from the power supply network—for instance for transport purposes—and
   (i) in the case of positive signals from the penetration sensor system of the secure environment of the further node, that is to say the signals that characterize a physical
   or logical penetration attempt, lead to destruction of the original secret,
   this results in another advantage of the solution according to the invention that the nodes of the network implementing the data processing system no longer have to be assembled, tested, checked and sealed in each case in different data centers for commissioning, but these process steps may be carried out in a standardized way in a central industrial factory. This reduces the probability of errors when executing these process steps, simplifies work organization for operators and auditors and lowers the costs of providing the data processing system. The reduction in the probability of errors also increases the quality and security level of the secure data processing system.
   In particular, the nodes according to the invention of the network implementing the data processing system in the one or more industrially organized factories may be sealed according to the invention and remain sealed despite the disconnection from the data transmission and power supply networks and ready for operation without further testing and inspection for the operative duration of the backup batteries or backup stores in another form. The nodes only have to be connected to the existing data transmission and power supply networks at the intended operating site and the nodes then connect to the other nodes for networked operation. The maintenance or repair of a node of the network implementing the data processing system that goes beyond the downloading of new software versions does not have to be carried out at the operating site in a complex manner, but rather nodes that are due for maintenance or repair are simply disconnected from the data transmission and power supply networks by unqualified staff, transported as a whole back to the industrially organized factory, revised there in the industrially organized environment, tested again, checked and sealed and transported again to the operating site and accordingly simply put back into operation.
7. Since the methods and devices according to the invention are also suitable for sealing nodes of a network implementing a data processing system for the efficient provision of a secure data processing system, wherein the signals from the penetration sensor system that characterize a penetration attempt lead to destruction of the original secret by interrupting the power supply to the volatile data memory, the data deletion that is implemented takes place in a particularly simple and therefore particularly favorable manner in terms of reliability and costs.
8. Since the methods and devices according to the invention are also suitable for sealing nodes of a network implementing a data processing system for the efficient provision of a secure data processing system, wherein the securing of the environment for the data processing optionally takes place individually or in combination in that
   (a) an encryption unit in the immediate vicinity of the central processing unit on the processor chips of the servers of the nodes only decrypts the data to be processed immediately before they are processed in the processing unit, and encrypts them even before the results of the processing step are written back to buses and working memories of the servers, or
   (b) the secure environment deletes the unencrypted data currently being processed in a node as a precautionary measure if this is indicated by the signals from the penetration sensor system characterizing a penetration attempt on the node,
the combination according to the invention of different approaches for “confidential computing”, namely (a) securing the confidentiality of the data processing at chip level in order to ward off attacks exploiting security gaps in the “middleware” and other system software and (b) securing the confidentiality of the data processing at multi-server level to ward off direct access and “side-channel attacks”, makes it possible to achieve a particularly high level of protection against breaches of confidentiality and integrity of the data processed by the data processing system.

Details and features of the invention as well as specific exemplary embodiments of the invention will become apparent from the following description in conjunction with the drawings. In the figures:

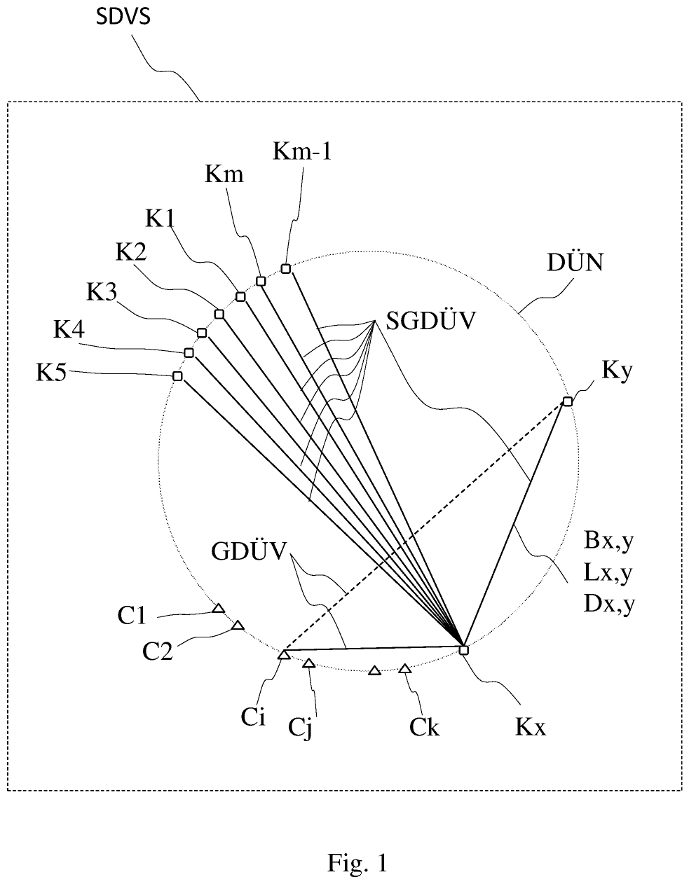

FIG. 1 shows a diagram of a secure data processing system according to the invention made up of nodes to explain the robustness against sabotage according to the invention with the reference signs:
SDVS Secure data processing system
K1 to Km Node 1 to node m
DÜN Data transmission network
GDÜV Secure data transmission connections
SGDÜV Specially secure data transmission connections
C1 to Ck Client 1 to client k
Bx,y Bandwidth of the data transmission connections from node x to node y
Lx,y Latency of the data transmission connections from node x to node y
Dx,y Geographical distance between the nodes x and y

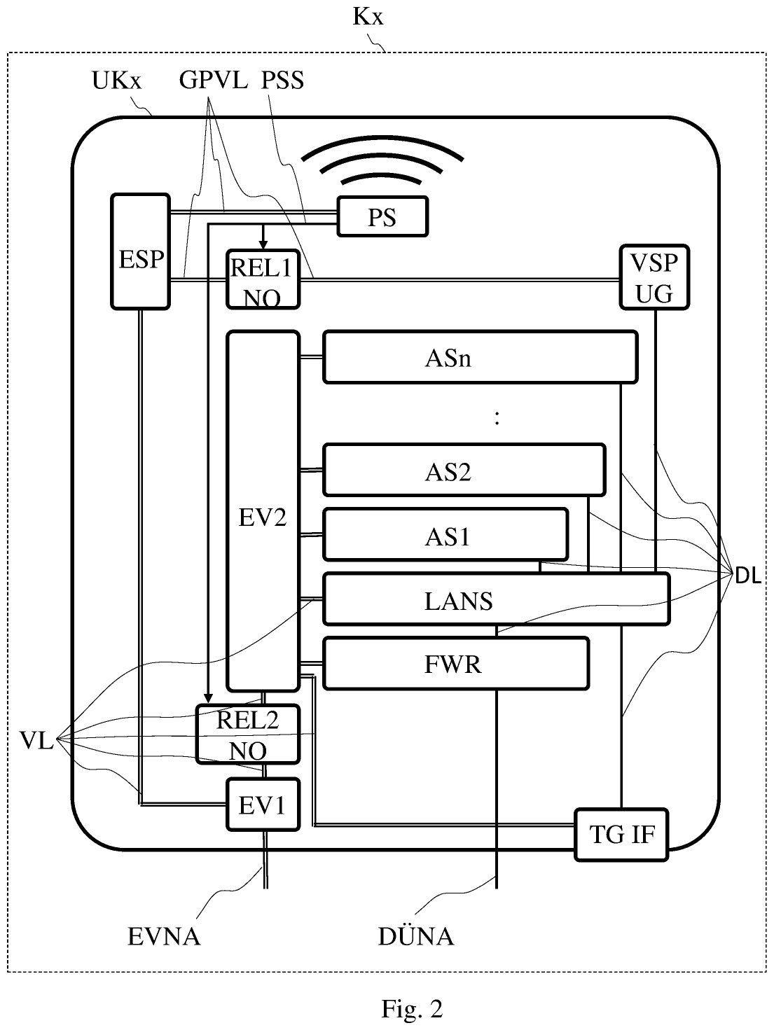

FIG. 2 shows a block diagram of a node of the network implementing the secure data processing system for explaining the sealing process according to the invention and the feature according to the invention that the sealing of the node is maintained even if the node is disconnected from the power supply and data transmission networks for a limited duration for transport purposes, with the reference signs:
Kx Node x
UKx Casing of the node Kx
EVNA Power supply connection
DÜNA Data transmission network connection
EV1 A first energy distributor
EV2 A second energy distributor
VL Supply lines
ESP Energy store
GPVL Buffered supply lines
REL1 NO Relay 1, normally open
REL2 NO Relay 2, normally open
PS Penetration sensor system
PSS Penetration sensor signal
VSP UG Volatile data store for the original secret
FWR Firewall Router
LANS Local Area Network Switch
AS1 to ASn Application server 1 to application server n
TG IF Partial secret input interface
DL Data lines

The devices according to the invention and the methods according to the invention enable both adequate protection against sabotage and simplification of the assembly, testing, checking, sealing, maintenance and repair of nodes of a network implementing a data processing system.

The multiplicity of m nodes K1, K2, to Km shown in FIG. 1, together with the k clients C1, C2, to Ck and with the specially secure data transmission connections (SGDÜV) of the data transmission network (DUN), form the secure data processing system (SDVS). The data transmission network (DÜV) may be for example the Internet, a private company network or even global networks supported by space satellites. The nodes K1 to Km may be designed for example as micro-data centers with just one or a few servers or large data centers with a large number of servers. The nodes are protected for example by firewall routers to the data transmission network DUN by only the required interfaces, characterized for example by protocols, addresses and ports, being opened by appropriate configuration of the routers. According to the invention, this configuration is carried out by system software of the secure data processing system SDVS, which is installed on each node K1 to Km or is downloaded from other nodes of the SDVS that are already in operation when the software is booted, and is preferably designed as a pure peer-to-peer software system and is able to make the appropriate configurations to the routers of the nodes via an interface. Through a pure peer-to-peer design of the system software function for registering new nodes of the network implementing the secure data processing system SDVS, new nodes register automatically and are automatically integrated into the SDVS, that is to say the configurations of the routers of all nodes of the network are updated by the system software of the SDVS and the resources for data processing are incorporated into the pool of resources of the SDVS by the system software.

Each node Kx (for x from 1 to m) may set up individually specially secure data transmission connections (SGDÜV) to all other nodes Ky (for y from 1 to m and other than x), which connections may differ depending on the expected values of the bandwidth Bx,y, the signal propagation time or latency Lx,y and the geographical distance between the nodes Dx,y. The specially secure data transmission connections SGDÜV may accordingly be both purely packet-switched, connection-oriented packet-switched connections and circuit-switched connections. The actual transmission may be both carried out in a wired manner, both via metal conductors or fiber-optic transmission paths, and via air interfaces, such as for instance mobile data transmission devices, or else in combination in sections. Due to the sealing of the nodes (explained below with reference to FIG. 2), each node Kx, where x=1 to x=m, has the same original secret UG and may use this UG to set up a cryptographically particularly secure cryptographically secure data transmission connection SGDÜV to the other nodes Ky, where y=1 to y=m and y other than x.

Each client Ci (for i from 1 to k) may set up a secure data transmission connection (GDÜV) to the node Kx, provided that a first instance of a data processing task bound to data processing resources of the node Kx has been initially configured, for example as an “ingress” to a service requested by the client Ci for the node Kx, that is to say the corresponding entries have been made in the firewall router associated with the node Kx. According to the invention, this is done by the system software of the secure data processing system SDVS, which is installed on each node K1 to Km and is able to implement the appropriate configurations via an interface to the routers of the nodes. The initial configuration process is carried out for example by the software developers using the SDVS and/or software as a service (SaaS) providers (hereinafter referred to as “tenants” of the SDVS) when they set up a service for the users of the SaaS offering. The routers communicate with the other routers of the data transmission network DUN, according to the associated switching system or protocol, for example the Domain Name Service (DNS) on the Internet. In addition to a first instance of the data processing task at the node Kx, with a DNS-A record of an Internet address of the node Kx on the Internet, for example, there is advantageously configuration of a second instance of the data processing task at another node Ky with an alternative address in the switching system belonging to the DUN, a DNS-B record of a second Internet address of the node Ky on the Internet for example. The alternative connection of the client Ci to the node Ky that is possible as a result is shown in dashed lines in FIG. 1.

Since the tenants set up the instances and, due to the way the switching system of the data transmission network DUN works, for example the DNS on the Internet, the mapping for example of a “Universal Resource Location” (URL) to the DNS-A records and the DNS-B records is distributed over a large number of nodes, for example the routers on the Internet, the addresses, characterizing the node Kx, of the DUN that is provided primarily for the data processing task associated with a service requested by a client Ci, and the addresses, characterizing the node Ky, of the DÜN which is provided secondarily, that is to say in the event that the node Kx is not available as a substitute for the data processing task associated with a service requested by a client Ci, may be known to potential attackers for acts of sabotage.

The system software of the SDVS according to the invention prepares further nodes for taking over the data processing tasks in addition to these nodes that are possibly known to potential attackers. For this purpose, the SDVS automatically and, advantageously by way of peer-to-peer system-implemented management, selects one or a plurality of invisible nodes Ka, Kb, Kc, etc. or nodes invisible to the tenants and the operator of the SDVS, which nodes should be prepared, as redundant, alternative resources, for taking over the data processing task. For this purpose, the routers of the selected nodes for the specially secure data transmission connections SGDÜV are set by the system software, and the functions of the management of the data processing tasks of the system software are configured. These may be for instance pods or virtual machines in currently popular cloud operating systems such as “Kubernetes” or “OpenStack”. Accordingly, these further nodes Ka, Kb, Kc, etc., which are provided for taking over the data processing task in the event that the node Kx and/or the node Ky are not available, cannot be known to the tenants or to the operator of the SDVS. The selection of the nodes Ka, Kb, Kc, etc. as replacement nodes for a specific data processing task is a secret hidden in the SDVS and this may only be kept a secret due to the secure data processing environment explained below with reference to FIG. 2 and the sealing thereof.

A modern data processing system performs a large number of data processing tasks simultaneously and in parallel. Therefore, in practice, in the system software of the SDVS according to the invention, a large number of configurations of the primary and secondary nodes, implemented manually or automatically by tenants, are set for a large number of data processing tasks and, for each of these data processing tasks, a settable number of further nodes, which are however concealed depending on the specific instantiation, are set autonomously by the system software.

As soon as the system software of one of the nodes K1 to Km, implemented for example by a “heartbeat” signal, recognizes the unavailability of one of the nodes or both nodes Kx and Ky, a new primary and/or a new secondary node is defined for the data processing tasks in question and the new records of the mappings of a URL or a first and a second URL to the address or the addresses of the nodes are published with a message to the switching system of the data transmission network DUN, on the Internet for example the DNS, the new primary and secondary nodes for each data transmission task. Since this process generally takes a relatively long time, for example several minutes, due to the distribution processes within the DUN, the SDVS according to the invention preferably publishes the addresses of two nodes for each service, a primary node Kx and a secondary node Ky. In the event that the primary node Kx is not available, the client Ci may issue the requests to complete the corresponding data processing task within a short time, for example a few seconds, by way of the alternative access to the service at the node Ky, and possibly receive the results of the data processing task from the node Ky.

According to the invention, the algorithm that the system software of the SDVS uses for the selection of the nodes Ka, Kb, Kc, etc., hidden from the tenants and the operator of the SDVS may use the expected values for the bandwidths of the SGDÜV between the node Kx and the nodes Ka, Kb, Kc, etc., Bx,a, Bx,b, Bx,c, etc., and between the node Ky and the nodes Ka, Kb, Kc, etc., By,a, By,b, By,c, etc., as parameters for the selection. In the same way, the expected values of the latencies Lx,a, Lx,b, Lx,c, etc., Ly,a, Ly,b, Ly,c, etc. as well as the geographic distances Dx,a, Dx,b, Dx,c, etc., Dy,a, Dy,b, Dy,c, etc. are also available to the algorithm for selecting the nodes Ka, Kb, Kc, etc. according to the invention.

Since the expected values of the bandwidths and latencies as well as the geographic distances between the nodes could be known to the operator of the SDVS and other people, and so the selection of the nodes Ka, Kb, Kc, etc. by the algorithm of the system software of the SDVS could be understood by potential attackers outside the SDVS, according to the invention, as one advantageous embodiment of the selection algorithm, provision is made for the expected values of the bandwidths and latencies as well as the geographical distances to be changed by random or quasi-random values, so that the operators of the SDVS or other people are not able to understand the selection process of the nodes Ka, Kb, Kc, etc. by the algorithm of the system software of the SDVS according to the specific result, and so the specific instantiation of the nodes Ka, Kb, Kc, etc. remains unknown and hidden from all people, including the tenants or the operator of the SDVS. Thus, no act of sabotage to be potentially feared is able to be directed in a targeted manner against the nodes Ka, Kb, Kc, etc.

A possible act of sabotage could at best be directed in a targeted manner against the nodes Kx and/or Ky, wherein, following the above-described publication of the respective addresses in the switching system of the DUN of the new primary and secondary node for each service affected, the affected services would be reachable again and so the saboteurs would not have achieved their goal. Only in the event that the saboteur or saboteurs succeeded in putting all nodes K1 to Km out of operation in a large-scale act of sabotage would the operation of the SDVS be disrupted and the services provided by the SDVS no longer be intact. The greater the number of nodes of the network implementing the secure data processing system SDVS, the greater the geographic distances Dx,y for x and y from 1 to m and x other than y, the more specially secure data transmission connections SGDÜV are set up between the nodes, the less probable it is that one saboteur or several saboteurs are able to succeed in putting all nodes K1 to Km out of operation at one time.

The nodes of the network implementing the SDVS are, as will be described in more detail below in the explanations regarding the structure of the nodes, advantageously constructed uniformly according to a common design plan and in particular with interfaces to the outside implemented in a uniform manner. The nodes contain in particular the components for networking with the other nodes, the networking of the components within the node, for example and typically the working memories, buses and processors for processing the data, but also the memories for persistent storage of the data before and after intermediate steps of the individual data processing tasks.

Although individual data processing tasks are executed in a node Kx primarily set up for this purpose, it is necessary, for the high availability of a service implemented with the resources of the SDVS, for the intermediate results of a data processing task that have to be persistent to be secured not only in the persistent storage of the node Kx but for the intermediate results, preferably before the next step of the data processing task is computed, also to be secured in the memory of the node Ky provided secondarily for the data processing task. Furthermore, according to the invention, such synchronous replication of the data is advantageously provided on one or a plurality of the further nodes Ka, Kb, Kc, etc. Accordingly, the expected values of the bandwidths and the latencies of the SGDÜV, by way of which the node Kx is connected to the node Ky and the nodes Kx and Ky are connected to the nodes Ka, Kb, Kc, etc., play an important role in the fast execution of the data processing task. Accordingly, the algorithm of the system software of the SDVS secretly searches the nodes Ka, Kb, Kc, etc., restricted only by the random or quasi-random disturbances of the expected values, for the expected values of the bandwidth and/or the latency.

In order not to suffer any disadvantageous losses in the performance of the processing of the data processing tasks as a result of the random or quasi-random disturbances in the values Bx,y, Lx,y and Dx,y required to obtain protection against sabotage, provision is made, according to the invention, in the algorithm of the system software of the SDVS, for the data of a data processing task to be persistent to be replicated synchronously advantageously on only a large subset of the nodes Ka, Kb. Kc, etc. connected to the nodes Kx and Ky, preferably by SGDÜV characterized by relatively high bandwidth and relatively short latency, possibly in a manner able to be set by the tenants, and for the data to be persistent to be replicated asynchronously only on the complementary other subset of the nodes Ka, Kb, Kc, etc. Asynchronous replication means that the continuation of the completion of a data processing task does not wait for confirmation of completion of the data securing of an intermediate result of the data processing task, like in synchronous replication, but rather that the intermediate results of the data processing task are copied to the other nodes in question with a lower priority in the background of the higher priority processing activities. Only in the highly improbable case of error or sabotage whereby none of the nodes Kx and Ky, as well as the subset of nodes Ka, Kb, Kc, etc. provided for the synchronous replication, are no longer operational, can that part of the results and intermediate results of the data processing task that has not yet finally been replicated asynchronously to the nodes of the complementary subset of nodes Ka, Kb, Kc, etc. be lost. However, in this unlikely case, all data already secured by the asynchronous replication is still in this subset of nodes Ka, Kb, Kc, etc., as a backup to restore the services impacted by the failure of the nodes Kx, Ky and the subset of nodes Ka, Kb, Kc, etc., to which synchronous replication is performed, and implemented by the resources of the SDVS.

Since a high degree of redundancy may be created by networking the nodes of the network implementing the secure data processing system with a large number of nodes, the redundancy that is otherwise customary in information technology at the individual nodes may be dispensed with according to the invention, and for the production, the configuration, testing and sealing of the nodes, the nodes advantageously remain equipped with only one, not a duplicated router instance, with only one data transmission network connection with only one internal local network, with only one connection to the power supply network, etc.

In addition, the distribution of the data processing tasks to a large number of nodes of the network implementing the data processing system favors a design of the nodes with routers with a smaller transmission capacity of the interfaces and smaller switching matrices and a design of the servers with smaller processing capacity, that is to say smaller working memories, smaller clock rates, etc. and is accordingly less tied to the oligopolistically dominated supplier markets and thus less exposed to the risk of a supply gap and makes it possible to avoid suppliers who are suspected of building backdoors in the components that are not visible to the users of the components.

The node Kx shown by way of example in FIG. 2 accordingly comprises the components of the node, the casing of the node Kx, UKx, the power supply network connection EVNA, the first energy distributor EV1, the energy store or energy buffer ESP, the penetration sensor system PS, the relay 1, which is normally open, REL1 NO, the volatile data memory for storing the original secret VSP UG, the relay 2, which is likewise normally open, REL2 NO, the second energy distributor EV2, the supply lines VL and the firewall router FWR, the local area network switch LANS, the application servers AS1 to ASn, the partial secret input interface TG IF, the data lines DL and finally the data transmission network connection DÜNA.

The node according to the invention, shown by way of example in FIG. 2, of the network implementing the secure data processing system, is used to explain the sealing process according to the invention and the feature according to the invention that the sealing of the node is maintained even if the node is disconnected from the power supply and data transmission networks for a limited duration for transport purposes.

The casing of the node Kx, UKx delimits the node Kx from its environment and serves to protect against physical penetration of the perimeter of the node Kx and, together with the further components of the node Kx, forms a secure environment for data processing and/or storage. The casing UKx may consist for example of a frame on which metal or other sheets are attached, or it may be a housing that is milled from a block or a housing that is produced using a pressure-casting process, such as aluminum pressure-casting. The casing UKx does not have to be impermeable to electromagnetic waves, that is to say it may thus for example be non-metallic or metallic and have slots or holes for air cooling, but may advantageously be implemented with reduced permeability to electromagnetic waves, in which case the heat dissipation from the application servers AS1 to ASn to the outer skin may take place for example using heat pipes. As an alternative, the waste heat may be conducted out of the casing UKx via systems of combined heat exchangers and/or heat pipes (not shown in the exemplary embodiment shown in FIG. 2) and supplied to other devices for further use of the heat energy.

The design of the node Kx as a secure environment and the protection of the node Kx against physical penetration serve to ensure that potential attackers are not able to tap off any signals, in which potentially relevant data that are required to carry out the data processing tasks are encoded, on the data lines DL or on the components firewall router FWR, switch LANS or on the application servers AS1 to ASn of the node Kx (defense against side-channel attacks). The data signals on the data lines DL are advantageously also encrypted not only when they are supposed to be transmitted to other nodes of the SDVS via the data transmission network connection DUNA, but also when the signals only transmit data between different servers AS1 to ASn within the node Kx, so that electromagnetic radiation cannot be used to tap off data.

The environment is secured according to the invention if an unauthorized access attempt is suspected through precautionary deletion of all non-persistent data within the node Kx. As soon as the penetration sensor PS detects a penetration attempt and a penetration sensor signal is present at the relay REL1 NO and at the relay REL2 NO, that is to say the energy activating the relay is disconnected—less advantageously, normally closed relays or components with a function comparable to a relay may also be used-both the volatile memory of the original secret VSP UG and the application servers AS1 to ASn, and optionally also the switch LANS and the firewall router FWR as well as the partial secret input interface TG IF, lose the power supply, for example the mains voltage, and as a result also the data stored in the volatile working memories, the buses and the processors before they are able to be captured by the potential attackers, for example copied. Since, according to the invention, all data of the data processing task are written to the persistent memory only in encrypted form, the environment is secured through precautionary deletion of the volatile data in order to implement minimum access protection. In addition or as an alternative, the environment may advantageously be secured using methods such as for example the “Intel Software Guard Extensions”, so that there are no unencrypted data from the data processing tasks outside the central processing units (CPU) of the processors of the application servers AS1 to ASn and accordingly protection is afforded against “exploits”, that is to say errors able to be used for attacks or intentionally built-in security weaknesses in the software, on the layers of the system software of the SDVS.

For the effectiveness of securing the secure environment, the protective effect of the encryption of the data on chip-level TEEs outside the CPU or on server-level or multi-server-level TEEs, the protective effect of the encryption of the data written to the persistent memories of the node Kx, for example the persistent memory of the application servers AS1 to ASn, is decisive. The read keys for decrypting this encryption must not be known to anyone. According to the invention, the keys used to encrypt the data written to the persistent memories of the node Kx are generated from an original secret UG that is identical in all nodes K1 to Km and that is stored in volatile form in each node K1 to Km in the volatile memory for the original secret VSP UG.

According to the invention, the original secret is generated and distributed to all nodes by initially automatically and randomly or quasi-randomly generating the original secret in a first node Kx and then splitting it into a plurality of partial secrets, Shamir parts, using the method known as “Shamir Secret Sharing” and distributing it to a plurality of mutually independent auditors, specifically advantageously by encrypting the respective partial secret with the public key of a personal certificate of the respective auditor and subsequently dispatching it thereto and during the audit, known as “scaling”, of each further node Ky, when and only when the auditors have reached the conclusion that the components of the node Ky, its procurement, arrangement and linking and its configuration correspond to the construction plan and the specification of the node of the SDVS, closing the node Ky and making it operational, for example by connecting the EVNA to the power supply network and the DUNA to the DUN, and then, at the request of the system software, entering the respective partial secrets in succession on the partial secret input interface TG IF, which is advantageously implemented as a component belonging fixedly to the node Kx, from which partial secrets, if a sufficient subset of the Shamir parts has been entered, the system software then generates the original secret UG and writes it to the volatile memory for the original secret VSP UG.

This original secret UG, which is identical for all nodes K1 to Km, is used as a cryptographic trust anchor for each node of the network implementing the data processing system, which means that when the node is started, for instance because the node is connected to the power supply network by way of the ENVA and to the DUN by way of the DUNA, the initialization and booting of the system software of the SDVS is only possible if the original secret UG, which corresponds to other nodes, is available for checking the authenticity of signatures with which the system software must be signed, the establishment of encrypted connections to the other nodes succeeds, wherein the keys used for encryption are derived from the original secret UG and the encryption of data that are written to the persistent memories, that is to say the intermediate results and results of the data processing tasks, is implemented using keys that are likewise derived from the original secret UG. The process of checking the system software before it is able to be used to initialize and boot the node Kx may take place in combination with the processes referred to as Trusted Boot or, for example, for the Intel Trusted Platform modules with “T-Boot”.

The present invention is characterized in particular by a novel operating concept, which is characterized in that the nodes of the network implementing the SDVS are not initially set up at their intended operating site, then configured and prepared for operation, as is customary in the industry, but rather the nodes can be constructed in central, industrially organized factories, checked by the auditors, closed, put into operation and sealed according to the invention as described above, then are disconnected again from the power supply network and from the data transmission network DÜN, packaged and transported to the intended operating sites by usual forwarding routes and the nodes are able to be put into operation there only by connecting the EVNA of the nodes to the power supply network and the DUNA of the nodes to the DUN. The nodes may then automatically integrate into the network implementing the data processing system.

In order for this novel operating concept to work, the nodes according to the invention, as shown in FIG. 2, are equipped with an energy store ESP, for example an electrical accumulator, which, even if the node Kx is disconnected from the power supply network, maintains the supply of energy to the penetration sensor PS and the volatile memory of the original secret VSP UG by way of the buffered supply lines GPVL for the period determined by the specifically implemented capacity of the ESP and the specifically implemented energy consumption of the PS and the VSP UG. This period is dimensioned such that the operation of the PS and the VSP UG is ensured for the transport duration required by the operating concept and the partial function of the secure environment, that is to say the protective capsule for the original secret, is accordingly also maintained in the state disconnected from the power supply network. If the penetration sensor PS detects a penetration or manipulation attempt during transport, then the supply line with buffered energy GPVL to the volatile memory of the original secret VSP UG is interrupted, for example by the relay 1 REL NO by way of the penetration sensor signal PSS, and for example as a result of the loss of the supply energy the original secret UG is deleted in the volatile memory of the original secret VSP UG. In this implementation example, the deletion also takes place without disconnecting the contact of the REL1 NO if the transport to the intended operating site takes too long, and the time of connection of the EVNA to the power supply network occurred too long after the disconnection from the power supply network in one of the central factories, and as a result, the energy reserve of the energy store ESP is exhausted by supplying the penetration sensor system PS and the volatile memory for the original secret VSP UG. In both cases, the integrity of the structure and the configuration of the node must be checked again, the node has to be closed and put into operation by a sufficient number of auditors who, by re-entering their respective partial secrets, reseal the node according to the invention, wherein the original secret UG is generated again and is written to the VSP UG. Advantageously, this renewed sealing does not take place at the intended operating site, but after return transport back to one of the central, industrially organized factories in which the assembly, testing and sealing processes may be designed for maximum efficiency.

In practice, the operating processes according to the invention make provision for the standardized nodes K1 to Km to be constructed and sealed according to their type and category in the central factories, for single ones or a plurality of these nodes to be set up at the intended operating sites and put into operation by connecting to the power supply and data transmission networks. The system software of the SDVS tracks the inventory of the nodes that have been in operation and are in operation distributed over all nodes of the network implementing the SDVS, so that the logistical process, for the replacement of nodes that have failed due to aging or system errors or nodes that have been automatically shut down due to penetration or manipulation attempts, may be made as efficient as possible. For example, not every failed node or node shut down according to the invention has to be individually replaced immediately, but rather it is possible to wait, within logistically related regions of the network implementing the SDVS, for a quota of nodes affected by the failure, for example 30% of the number of nodes implementing the SDVS in this region, before the affected nodes are replaced by newly sealed nodes according to the invention in an efficient logistical process.

The sealing according to the invention of the nodes of the network implementing the data processing system implements the security of the environments of the nodes according to the invention, which is advantageous for the distribution according to the invention of the data processing tasks to a plurality of nodes of the network implementing the data processing system. Conversely, the distribution according to the invention of data processing tasks to a plurality of nodes of the network implementing the data processing system is advantageous for the reduction according to the invention in the complexity of the nodes, in particular the non-redundant design of an individual node and the design of an individual node with reduced capacity and performance.

1. A method for distributing data processing tasks to the nodes of a network implementing a data processing system, wherein
(a) a secure environment of the nodes largely prevents unauthorized access by third parties or the staff of the operator of the data processing system,
(b) the secure environment of a first node initializes the primary instance of a data processing task,
(c) the one or more secure environments of at least one second node or further nodes initializes the secondary instance or further instances of a data processing task, and
(d) in the secure environments of the nodes, software-controlled preparation of a plurality of nodes as further instances for the alternative execution of the data processing task takes place by means of pure peer-to-peer management that operates in a manner concealed from the users of the data processing system and the staff of the operator of the data processing system.

2. The method as claimed in claim 1, wherein the expected values for the data transmission capacities and signal propagation times between the nodes are taken into consideration as criteria of the selection method for the nodes implemented by the pure peer-to-peer management for the preparation of further instances.

3. The method as claimed in claim 2, wherein the expected values for the data transmission capacities and/or the signal propagation times for at least one further node and the first node are not deterministic, but rather randomly or quasi-randomly changed expected values are taken into consideration as criteria of the selection method for the nodes implemented by the pure peer-to-peer management for the preparation of a secondary instance.

4. The method as claimed in claim 2, wherein the expected values for the data transmission capacities and/or the signal propagation times between the first node and others are taken into consideration in a manner differentiated by purpose for the synchronous and asynchronous replication of the data as criteria of the selection method for the nodes implemented by the pure peer-to-peer management for the preparation of a secondary instance.

5. The method as claimed in claim 1, wherein the nodes of the network implementing the data processing system are designed without local redundancies, that is to say without duplication or higher redundancy in the same node.

6. A method for sealing nodes of a network implementing a data processing system for efficiently providing a secure data processing system, wherein
(a) a secure environment of a first node randomly or quasi-randomly generates an original secret,
(b) the secure environment of the first node breaks down the original secret into a plurality of partial secrets,
(c) the secure environment of the first node issues the partial secrets to predetermined auditors,
(d) a secure environment of a further node receives the partial secrets (after the node has been successfully checked by the auditors) at an interface able to be securely assigned to the node,
(e) the secure environment of the further node generates the original secret from a sufficient subset of the partial secrets,
(f) the secure environment of the further node stores the original secret in a volatile data memory provided for this purpose,
(g) the secure environment of the further node uses the original secret as a cryptographic trust anchor for the start of all further functions of the node signed by the auditors, in particular for the “boot” of the entire “software stack” as well as for the derivation of the keys for the secure persistence of the intermediate results of the data processing tasks and for secure communication between the nodes,
(h) an energy store supports both a penetration sensor system and the volatile data memory of the secure environment of the further node for a time determined by the capacity of the energy store, even if the node is disconnected from the power supply network—for instance for transport purposes—and
(i) in the case of positive signals from the penetration sensor system of the secure environment of the further node, that is to say the signals that characterize a physical or logical penetration attempt, lead to destruction of the original secret.

7. The method as claimed in claim 1, wherein the signals from the penetration sensor system characterizing a penetration attempt lead to destruction of the original secret by interrupting the power supply of the volatile data memory.

8. The method as claimed in claim 6, wherein the environment for the data processing is optionally secured individually or in combination in that
(a) an encryption unit in the immediate vicinity of the central processing unit on the processor chips of the servers of the nodes only decrypts the data to be processed immediately before they are processed in the processing unit, and encrypts them even before the results of the processing step are written back to buses and working memories of the servers, or
(b) the secure environment deletes the unencrypted data currently being processed in a node as a precautionary measure if this is indicated by the signals from the penetration sensor system characterizing a penetration attempt on the node.

9. A device for distributing data processing tasks to the nodes of a network implementing a data processing system, wherein the device is adapted to carry out a method as claimed in claim 1.

10. A device for sealing nodes of a network implementing a data processing system for the efficient provision of a secure data processing system, wherein the device is adapted to carry out a method as claimed in claim 6.

11. The method as claimed in claim 3, wherein the expected values for the data transmission capacities and/or the signal propagation times between the first node and others are taken into consideration in a manner differentiated by purpose for the synchronous and asynchronous replication of the data as criteria of the selection method for the nodes implemented by the pure peer-to-peer management for the preparation of a secondary instance.

12. The method as claimed in claim 6, wherein the signals from the penetration sensor system characterizing a penetration attempt lead to destruction of the original secret by interrupting the power supply of the volatile data memory.

13. The method as claimed in claim 7, wherein the environment for the data processing is optionally secured individually or in combination in that
(a) an encryption unit in the immediate vicinity of the central processing unit on the processor chips of the servers of the nodes only decrypts the data to be processed immediately before they are processed in the processing unit, and encrypts them even before the results of the processing step are written back to buses and working memories of the servers, or
(b) the secure environment deletes the unencrypted data currently being processed in a node as a precautionary measure if this is indicated by the signals from the penetration sensor system characterizing a penetration attempt on the node.

14. A device for distributing data processing tasks to the nodes of a network implementing a data processing system, wherein the device is adapted to carry out a method as claimed in claim 6.

15. A device for sealing nodes of a network implementing a data processing system for the efficient provision of a secure data processing system, wherein the device is adapted to carry out a method as claimed in claim 7.

16. A device for sealing nodes of a network implementing a data processing system for the efficient provision of a secure data processing system, wherein the device is adapted to carry out a method as claimed in claim 8.
